(19) United States
(12) Patent Application Publication
(10) Pub. No.: US 2011/0307294 A1
(43) Pub. Date: Dec. 15, 2011

(54) DYNAMIC GENERATION OF PRODUCTS FOR ONLINE RECOMMENDATION

(75) Inventors: Gilad Barkai, Haifa (IL); Nadav Har'El, Haifa (IL); Haggai Roitman, Qiryat-Ata (IL); Michal Shmueli-Scheuer, Haifa (IL)

(73) Assignee: International Business Machines Corporation, Armonk, NY (US)

(21) Appl. No.: 12/797,621

(22) Filed: Jun. 10, 2010

(51) Int. Cl. G06Q 99/00; G06Q 50/00; G06Q 30/00; G06Q 10/00

(52) U.S. Cl. 705/7.29; 705/347; 705/26.7; 705/27.1

(57) ABSTRACT

A method, system, and computer program product for dynamic generation of products for online recommendation. The method includes receiving a signal and processing the signal to extract one to many features and locating baseline products and embeddable items relating to the features a baseline product is dynamically matched with one or more embeddable items to generate a combined product and a representation of the combined product is provided as an online recommendation for a product;

### BACKGROUND

This invention relates to the field of online product recommendation. In particular, the invention relates to dynamic generation of products for online recommendation.

Current retail advertisement is static and inflexible. The set of products that can be advertised for sale is bounded by the actual availability of those products on the seller's side.

Product customization web sites are available through which a user can order a product customized with user selected content. For example, Zazzle (Zazzle is a Trade Mark of Zazzle Inc.) enables individuals, professional artists, and major brands to create and offer unique products for customers. Zazzle has its own product base covers that includes t-shirts, business cards, invitations, in addition to a variety of custom gifts. Upon creation, products are instantly and accurately visualized on the site and offered in the Zazzle marketplace. When ordered, each product is made on-demand.

Personalization for advertisement and recommendation is also bounded by the set of features of existing available products.

### BRIEF SUMMARY

According to a first aspect of the present invention there is provided a method for dynamic generation of products for online recommendation, comprising: receiving a signal and processing the signal to extract one to many features; locating baseline products and embeddable items relating to the features; dynamically matching a baseline product with one or more embeddable items to generate a combined product; providing a representation of the combined product as an online recommendation for a product; wherein said steps are implemented in either: computer hardware configured to perform said identifying, tracing, and providing steps, or computer software embodied in a non-transitory, tangible, computer-readable storage medium.

According to a second aspect of the present invention there is provided a computer program product for dynamic generation of products for online recommendation, the computer program product comprising: a computer readable storage medium having computer readable program code embodied therewith, the computer readable program code comprising: computer readable program code configured to: receive a signal and processing the signal to extract one to many features; locate baseline products and embeddable items relating to the features; dynamically match a baseline product with one or more embeddable items to generate a combined product; and provide a representation of the combined product as an online recommendation for a product.

According to a third aspect of the present invention there is provided a system for dynamic generation of products for online recommendation, comprising: a processor; an incoming signal processing component for receiving a signal and processing the signal to extract one to many features; a retrieving component for locating and retrieving baseline products and embeddable items relating to the features; a matching component for dynamically matching a baseline product with one or more embeddable items to generate a combined product; and a recommendation output component for providing a representation of the combined product as an online recommendation for a product.

According to a fourth aspect of the present invention there is provided a method for providing a service to a customer over a network for dynamic generation of products for online recommendation, comprising: receiving a signal and processing the signal to extract one to many features; locating baseline products and embeddable items relating to the feature; dynamically matching a baseline product with one or more embeddable items to generate a combined product; providing a representation of the combined product as an online recommendation for a product; wherein said steps are implemented in either: computer hardware configured to perform said identifying, tracing, and providing steps, or computer software embodied in a non-transitory, tangible, computer-readable storage medium.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic flow diagram illustrating dynamic generation of products in accordance with the present invention;

FIG. 2 is a flow diagram of a method in accordance with the present invention;

FIG. 3 is a block diagram of a system in accordance with the present invention;

FIG. 4 is a block diagram of a computer system in which the present invention may be implemented;

FIG. 5 is a diagram showing an example web browser user interface with generated products for online recommendation in accordance with the present invention; and

FIG. 6 is a diagram showing an example microblogging interface with generated products for online recommendation in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

A method, system and computer program product are described in which products are dynamically generated with embedded items for online recommendation in response to an online signal.

Given a signal such as direct signal from the user (for example, search keywords, contextual content such as browsing history, or the user's profile) or some external signal (for example, an event occurrence or some trending topic), the system dynamically generates a set of products for recommendation to the user that best fit the signal. Generated products are not required to pre-exist in the system, and new products may be dynamically generated for recommendation, based on the signal and the system decisions.

If the user selects some product for purchase, the system is capable of conducting an order for that specific product for the user. The system will be able to generate every product it recommends in case the user chooses to purchase one of the products. For example, this may be either by having its own capability to generate the product and ship it to the user, or by utilizing third-party services that provide means to submit an order for the specific generated product with its required specification. The system supports multiple manufacturers making the same or different types of items, allowing the customers much more variety in products, printing technology, and prices.

The system is flexible and can utilize different sources for embeddable items for the dynamic product generation. Some of these sources can be photo databases (for example, photos taken from public available photo stock-markets such as http://www.gettyimages.com, http://www.sxc.hu/ and “royalty free images” on http://www.fotolia.com/Services/API/Introduction), databases of recent events or trending topics (for example, recent quotes such as those provided by http://www.quotationspage.com), or product features supported by online product ordering services (for example, product colors available in the API of http://www.zazzle.co.uk/api).

The system recommends designs on-the-fly from the individual building blocks of the products on one hand and separate images, texts, and other embeddable items on the other hand, from possibly many separate sources.

The system can further utilize user profiles to personalize the generation of products for recommendation to its users.

The system is also capable of calculating the price of each dynamically generated product, using its baseline cost, its enhanced features costs, its production/order costs, and shipment costs.

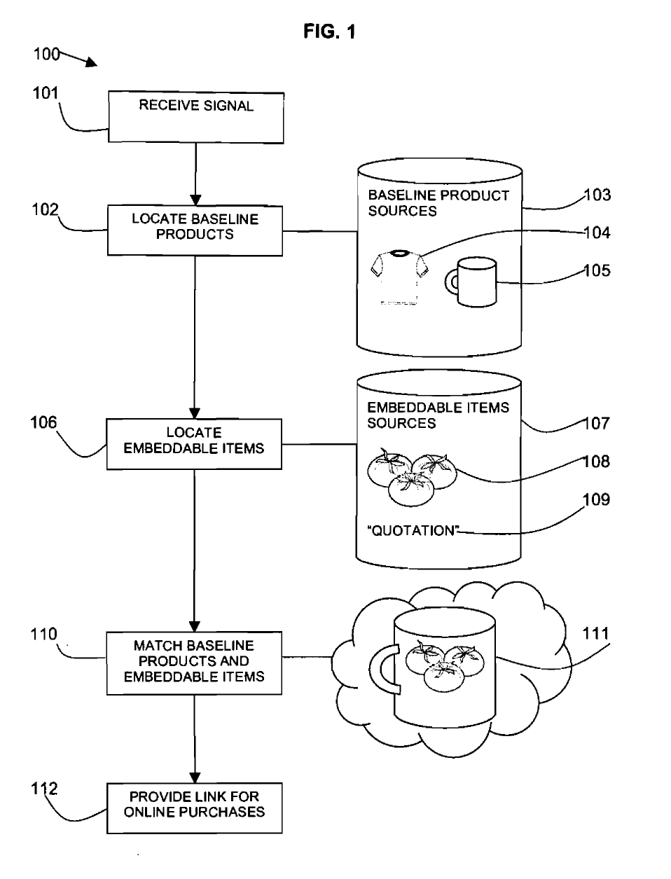

Referring to FIG. 1, a schematic flow diagram 100 shows the described method of dynamic product generation. A signal is received 101 including an optional user profile. The signal is processed to extract one to many features.

Baseline products relating to the features are located 102 from baseline product sources 103. For example, baseline products such as t-shirts 104 and mugs 105 are illustrated. Embeddable items relating to the features are also located up 106 from embeddable item sources 107. For example, images 108 or text 109 are illustrated as possible embeddable items.

Baseline products are dynamically matched 110 to embeddable items and a representation provided 111. A mug with an embedded image is shown 111. Links for online purchase of the generated combined product are provided 112.

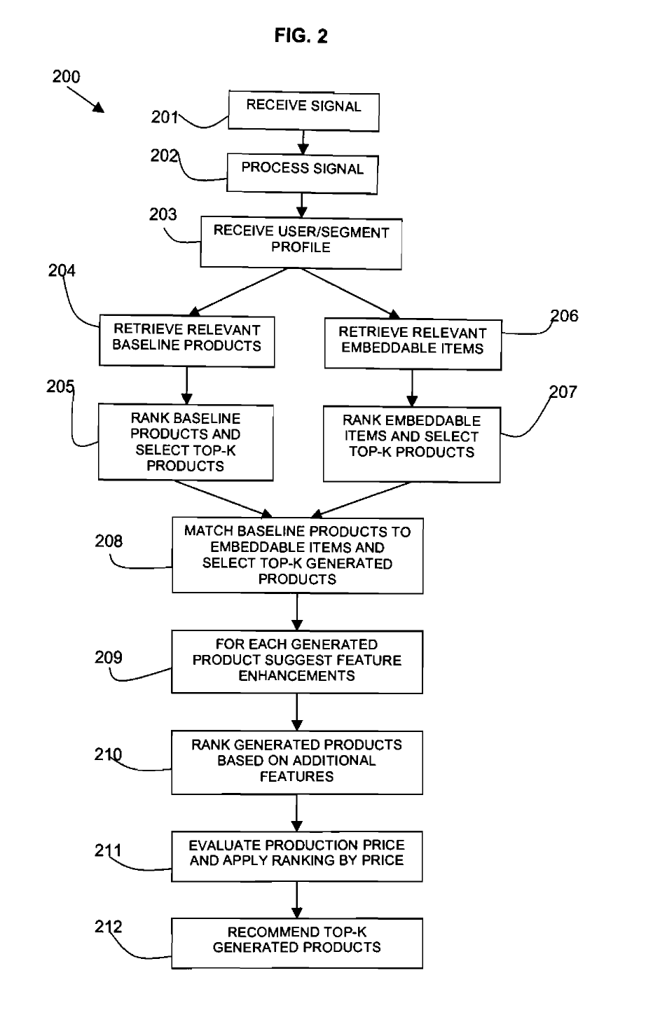

FIG. 2 is a flow diagram 200 of the described method in more detail. A signal is received 201 (for example, search keywords, event occurrence details, new trending topic trigger) during an online session. The signal is processed 202 (for example, to extract keywords, do stemming, data cleaning, etc.) to extract a set of one to many features. Optionally, a user profile or segment profile for a segment of users is also received 203 to provide information on the online user(s) of the session.

Using the signal and possibly also a user or segment profile, relevant baseline products are looked up relating to the features and retrieved 204 from a baseline products database. Such lookup is done by mapping the signal onto features of baseline products. For example, by utilizing existing annotations on baseline products (e.g., categories, tags, etc.), or existing mappings or rules (e.g., IF signal contains the keyword “band” THEN suggest t-shirt), or even by applying collaborative filtering algorithms (e.g., similar users to the current user profile, usually purchased t-shirts) or searches (e.g., if the signal is the word “mom”, a Web search turns up that “mom mug” is more popular than “mom shirt” so recommend a mug, while if the signal is “obama”, a similar search indicates the recommendation of a shirt).

To reduce the product search space, some ranking function 205 is used (e.g., by relevance) to rank the set of candidate baseline products. Personalization can take place if a user or segment profile of the specific user/segment is to be used for recommendation.

In parallel with steps 204 and 205, using the signal and possibly also a user or segment profile, relevant embeddable items to be embedded within the products are looked up and retrieved 206. An embeddable item is any content or media item that can be embedded within a baseline product (given that there is a capability to do that, e.g., printing a label on a T-Shirt). For example, given the signal, the system may retrieve relevant pictures, logos, slogans, etc. that fit the signal. Such lookup can be done by mapping the signal onto embeddable items. For example, by utilizing existing annotations on baseline products (e.g., categories tags, etc.), or existing mappings or rules (e.g., IF signal contains the keyword “band” THEN suggest a “band logo”), or even by applying collaborative filtering algorithms (e.g., similar users to the current user profile, usually purchased baseline products with some specific logo).

To reduce the embeddable item search space, some ranking function (e.g., by relevance) 207 may be used to rank the set of candidate embeddable items. Personalization can take place if a user or segment profile of the specific user/segment is to be used for recommendation.

The system 208 matches the baseline products with the embeddable items. There are several methods which may be used to solve such a matching problem. These include: using linear programming, graph-algorithms, and game-theoretic algorithms. In this stage, the product configuration is considered which is one product with one to many items.

In one embodiment, the problem is represented as a matching problem, where there is a (bi-partite) graph with two disjoint vertex sets and a set of graph edges that connect pairs of vertexes; each vertex comes from one of the sets (so there is no edge between vertexes that belong to the same vertex set). In this case, the first vertex set is the set of candidate base products, the second set is the set of embeddable items. An edge weight represents the relative relatedness (“fitness”) between a certain baseline product and a certain embeddable item.

When a matching algorithm is run on such graph, the result is a matching that selects for each product the best items, or for each item the best products. The matching can return for each product the set of top-k items to be used.

For example, one possible weighting function can be based on the embeddable item dimensions/size, e.g., a certain embeddable image may fit to be printed over a t-shirt, but not over a coffee cup, due to visibility constraints. The system selects the top-k best combination pairs (baseline product, embeddable items). Personalization can take place if a user/segment profile of the specific user/segment is to be used for recommendation.

Given each combination pair (baseline product, embeddable items), additional feature enhancements are suggested 209. For example, a baseline product color may be changed from white color to pink. For each such pair, a set of 0 to more possible enhancements may be suggested, where the method validates that for each proposed product that there is a capability to actually manufacture the product or order it from one of the third-party providers.

The generated products (with and without feature enhancements) are ranked 210 and the method selects the top-k generated products to recommend or advertise.

The price of each product is evaluated 211. Such price may include the baseline product costs, its embeddable item cost, enhancement costs, its in-house or out-sourced manufacturing price, and its shipment price. The system may apply additional ranking based on the calculated price.

The method recommends 212 top-k products and enables a user purchase the product (for example, by clicking on some hyperlink).

In one embodiment, the following method may be used to finding the best product configuration.

Input:
Initial signal s.
List baseline products P={p1, p2, . . . , pn}, each product further has a score Rel(pls) representing the relevance of the signal to the product.
List of embeddable items E={e1, e2, . . . , em}, each item further belongs to some type. Each embeddable item may further have several properties, some are shared among all items independently of the item type (e.g., relevance to signal Rel(els), Size(e), Price(e), recency with respect to signal Rec(els), etc.), some are more specific to the item type (e.g., color/edge histogram for pictures Color(e), length in word-count for quotes Len(e), etc.).
One or more system objectives: e.g., max configuration relevance, min configuration price, min configuration size, max configuration recency, max configuration “matchability”, etc.
List of production constraints (can be inferred from the production specifications, or using rules), e.g., upper bound on price, lower bound on recency or relevance, or matchability.

Output: Top-k product configuration list of pairs (p,Eₚ) where p is a baseline product and Eₚ is a list of embeddable items to embed on p according to its production capabilities.

Example Objectives

$$Maximum relevance \text{:} { \sum }_{ e ∈ Configuration} rel ( e \vert s )$$

$$Maximum recency \text{:} { \sum }_{ e ∈ Configuration} {exp}^{- rec ( e \vert s )}$$

$$Minimum price : { \sum }_{ e ∈ Configuration} price ( e )$$

$$Maximum matchability \text{:} avg {\sum }_{{e}_{i} ∈ configuration} {\sum }_{{e}_{j} ∈ configuration} match ( {e}_{i} , {e}_{j} \vert s , p )$$

$$where \text{:} match ( {e}_{i} , {e}_{j} \vert s , p ) = \frac{rel ( {e}_{i} , {e}_{j} \vert s , p )}{rel ( {e}_{i} \vert s , p ) rel ( {e}_{j} \vert s , p )}$$

Maximum coherency, for example, colour coherency:

$$avg {\sum }_{{e}_{i} ∈ configuration} {\sum }_{{e}_{j} ∈ configuration} sim ( color ( {e}_{i} ) , color ( {e}_{j} ) )$$

Example Constraints

$$Upper bound on price \text{:} { \sum }_{ e ∈ Configuration} price ( e ) \leq max price$$

$$Lower bound on relevance \text{:} { \sum }_{ e ∈ Configuration} rel ( e \vert s ) \geq min relevance$$

$$Lower bound on coherency \text{:} coherency ( configuration ) \geq min coherency$$

$$Lower bound on matchability \text{:} matchability ( configuration ) \geq min match$$

$$Upper bound on size \text{:} { \sum }_{ e ∈ Configuration} size ( e ) \leq max size$$

Possible Solution Techniques

Case One: Single Objective.
Constraint satisfaction problem (CSP);
Approximation algorithms (for example, solution to maximum budgeted cover);
Heuristic search and randomized algorithms (for example, gradient methods);
Etc.

Case Two: Multiple Objectives.
Direct multi-objective approximation;
Skyline query model;
Single objective representation (for example, objective smoothing and weighting);
Etc.

Product Building Scheme: Greedy Implementation.
For each product pεProducts.
Find best configuration for product p given signal s and items E.
If best configuration better than previous product best configuration, replace with current best configuration.
Return best product.
For top-K, a buffer of K best products should be maintained.

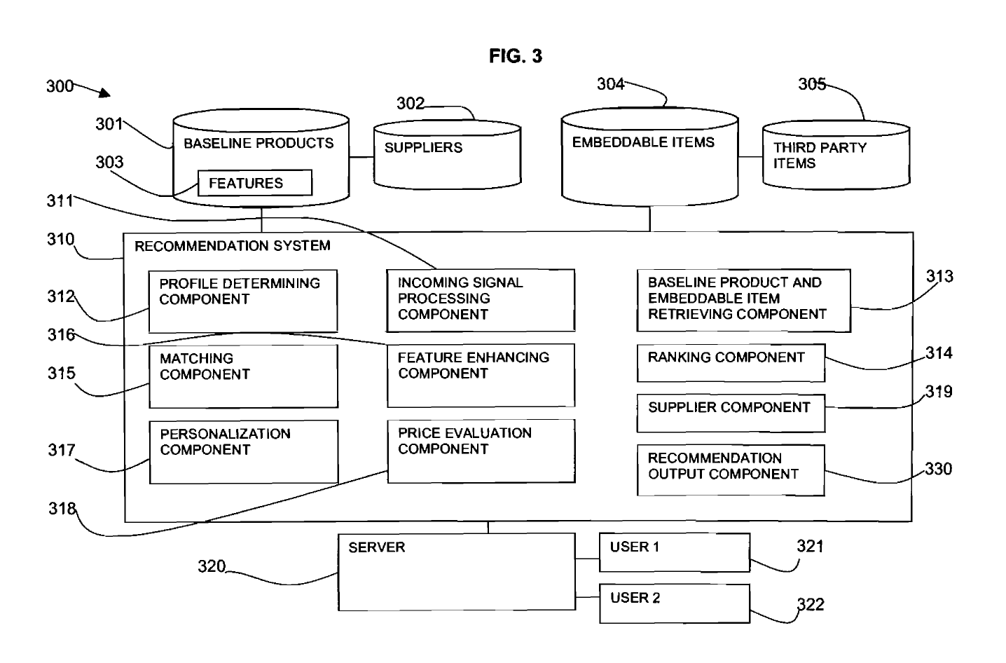

Referring to FIG. 3, a block diagram shows system 300 for dynamic generation of products for online recommendation.

The system 300 includes a server 320 providing an online service, such as a search engine, a social network service, a microblogging service, etc. The server 320 has one or more online users 321-322 who use the online service provided by the server 320. A recommendation system 310 is provided which receives an input signal from the server 320 and recommends dynamically generated products for advertisement on the online service of the server 320.

The system 300 includes a database of baseline products 301 that it can recommend. A baseline product is defined as a product in its “crude” form (for example, a plain white T-Shirt with no additional features). The database of baseline products 301 includes a “mapping” to suppliers 302 to contact to order the supply of a product. The suppliers 302 may be an “in-house” supplier of the recommendation provider or one or more third party suppliers. For each a baseline product as provided by a supplier, the system also maintains a list of “production” capabilities or features 303 of the baseline product. For example, a third party may provide the means to change the color of the product (e.g., t-shirt color), print labels on it, determine its fonts, texture, etc.

The system 300 maintains different data sources of embeddable items 304 that can be used to generate dynamic products on top of the baseline products 301. Such data sources can index various content and media types and provide features for the enhancement of baseline products 301 (for example, images, quotes, trending topics, slogans, etc.). The system 300 can also include additional external databases of third parties 305 that permit publishing of their royalty free content or trade marked (TM) logos, symbols, slogans, etc., as part of the features for products generated by the system.

Therefore, for each product that the system may generate, one or more embeddable item can be embedded with the product, or the products generic product features may be modified (e.g., color, size, etc.).

The system 300 includes a recommendation system 310. The recommendation system 310 includes a signal processing component 311 that is capable of receiving and processing a signal. The signal may be an external event or a user input. The signal processing component 311 may include trend monitors for monitoring real-time media sources and service APIs for obtaining signals from content providers. A profile determining component 312 may also be provided to obtain a user or segment profile of users of an online session.

The recommendation system 310 includes a baseline product and embeddable item retrieving component 313 which uses the processed signal to retrieve the most appropriate baseline products 301 and embeddable items 304. A ranking component 314 may rank the retrieved baseline products 301 and embeddable items 304. A matching component 315 matches the retrieved baseline products 301 and embeddable items 304. A baseline product 301 may be matched with one or more embeddable items 304 to form a combined product. A feature enhancing component 316 can be used to enhance the combined baseline line product 301 and embeddable item(s) 304 by adding product features 303. Again, the ranking component 314 may be used to rank the combined products.

Additionally, a personalization component 317 can use a determined profile of the user or segment of users to personalise the combined product by adding product features 303 dependent on the profile. This enables the system to generate more “targeted” dynamic products according to the user's/segment's taste.

A price evaluation component 318 is provided to evaluate a price for the combined product. The price evaluation component 318 is capable of evaluating the price of each generated combined product, depending on it baseline cost, its different enhancements' costs taken from external sources (e.g., photos), and its actual production and shipment costs.

The recommendation system 310 further includes a supplier component 319 that can interact with third-party suppliers 302 (for example, as a web-service API) that are capable of supplying the recommended combined products if they are not supplied by the recommendation system provider.

Finally, the recommendation system 310 includes a recommendation output component 330 including different ranked options with prices, with links to ordering and external suppliers 102.

A products generation network can be generated with the concept of “mashing up” content providers to publish product recommendation. Focused crawling may be used for discovering product generation web sites and APIs. Focused crawling may also be used with monitoring of royalty-free content that can be used to generate products. Exposure of an API to external brands may be provided that wish to provide their royalty-free content. External collection of signals may be provided to trigger the recommendation.

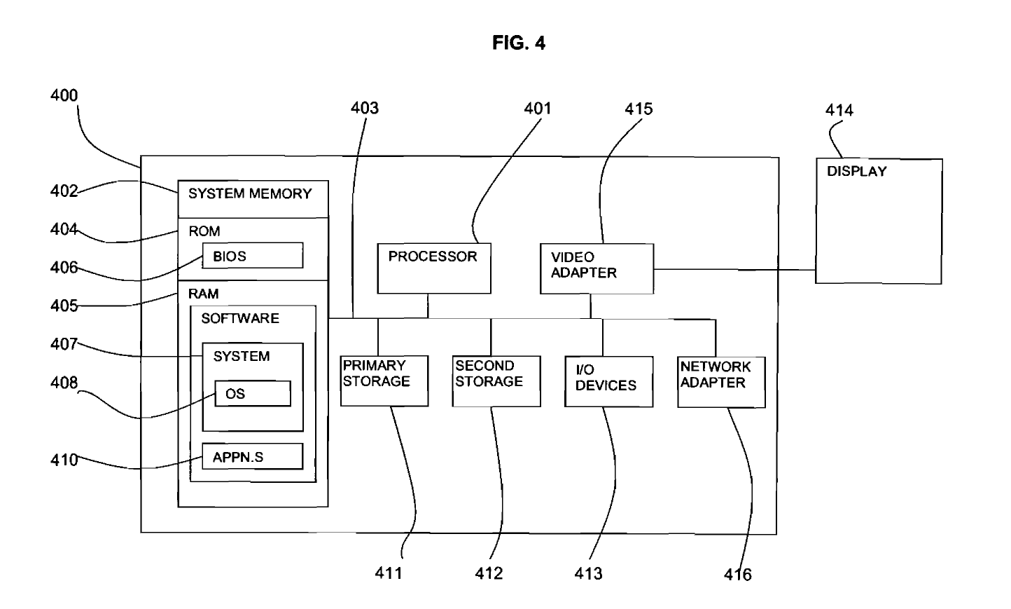

Referring to FIG. 4, an exemplary system for implementing aspects of the invention includes a data processing system 400 suitable for storing and/or executing program code including at least one processor 401 coupled directly or indirectly to memory elements through a bus system 403. The memory elements can include local memory employed during actual execution of the program code, bulk storage, and cache memories which provide temporary storage of at least some program code in order to reduce the number of times code must be retrieved from bulk storage during execution.

The memory elements may include system memory 402 in the form of read only memory (ROM) 404 and random access memory (RAM) 405. A basic input/output system (BIOS) 406 may be stored in ROM 404. System software 407 may be stored in RAM 405 including operating system software 408. Software applications 410 may also be stored in RAM 405.

The system 400 may also include a primary storage means 411 such as a magnetic hard disk drive and secondary storage means 412 such as a magnetic disc drive and an optical disc drive. The drives and their associated computer-readable media provide non-volatile storage of computer-executable instructions, data structures, program modules and other data for the system 400. Software applications may be stored on the primary and secondary storage means 411, 412 as well as the system memory 402.

The computing system 400 may operate in a networked environment using logical connections to one or more remote computers via a network adapter 416.

Input/output devices 413 can be coupled to the system either directly or through intervening I/O controllers. A user may enter commands and information into the system 400 through input devices such as a keyboard, pointing device, or other input devices (for example, microphone, joy stick, game pad, satellite dish, scanner, or the like). Output devices may include speakers, printers, etc. A display device 414 is also connected to system bus 403 via an interface, such as video adapter 415.

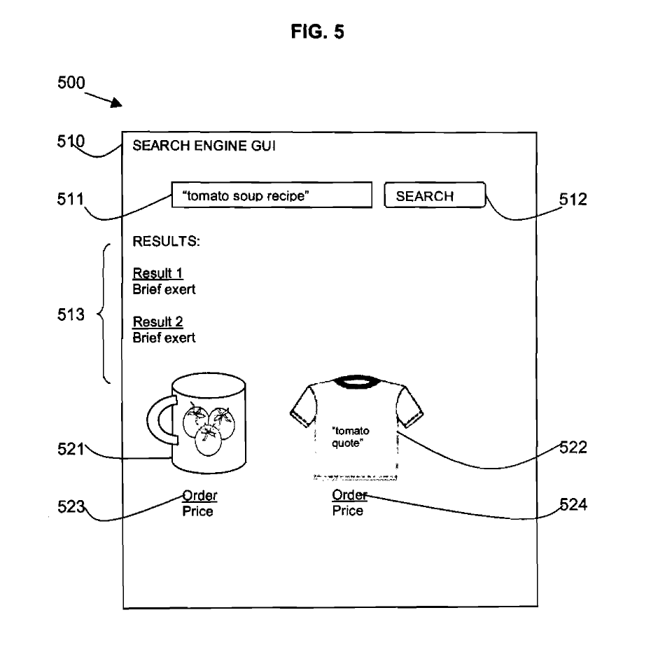

Referring to FIG. 5, a diagram shows a graphical user interface of a search engine 500, showing a results page 510. A query term input box 511 has a query term input by a user, for example, “tomato soup recipe”. A search button 512 activates a search for the query term.

Results 513 are listed, usually with hyperlinks to relevant web pages. In addition, the described method and system provide online advertisements 521-522 for products dynamically generated with reference to the input of the query term and, optionally, the profile of the user making the input. In this example, a t-shirt is generated with an image of a tomato 521 and a mug is generated with a quote relating to tomatoes 522. The advertisements 521-522 include hyperlinks 523-524 for ordering the products including links to third party suppliers.

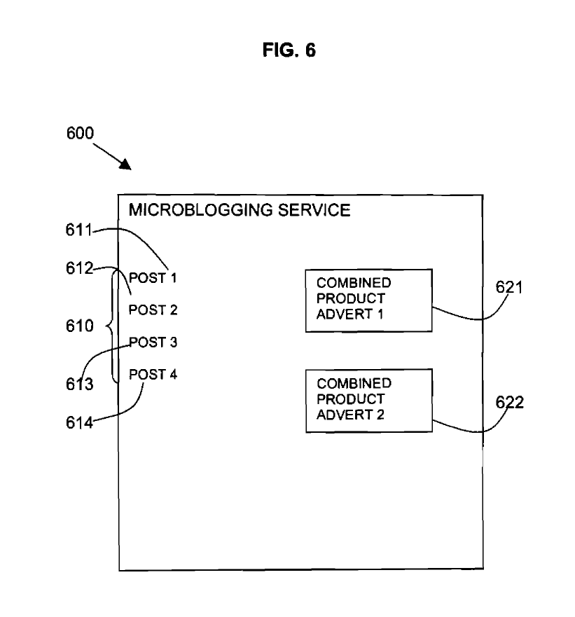

Referring to FIG. 6, a diagram shows a graphical user interface of a microblogger service 600. A stream 610 of microblog posts 611-614 are displayed to a user. A trend of the stream 610 may be determined. The described method and system provide online advertisements 621-622 for products dynamically generated with reference to the input of the microblogging trend and, optionally, the profile of the user of the microblogging service.

For example, a user may catch up with the latest “tweets” of her friends on Twitter and may be recommended a t-shirt that contain a logo relating to the latest hot trending topic on Twitter, for example, “Keep The Wave Going”.

In a further example, during the Halloween holiday, a user reads a blog relating to the release of a new product. The system recommends to the user a coffee mug with a pumpkin superimposed on the logo of the new product. In this case, the signal is the current date combined with the user's input.

In the described method a three-phase recommendation solution is suggested, which separates the baseline product space from the embeddable items (features) space. First suggestions are generated for both sets, then a third step matches recommended baseline products to recommended baseline embeddable items. Next phases in the process are used to further refine recommendation based on production capabilities and personalization.

In addition, it is possible to generate a product with several embeddable items (e.g., image and quote) and a decision may be required on how much the features themselves are inter-related or a surprise (for example: a t-shirt example with a tomato image and quote on tomatoes in which case the two are well inter-related). In the Twitter trend example given above, the trend itself is inter-related to a Wave image, and the Twitter icon may provide the surprise and context for recommendation).

The method may include continuous collection of features for dynamic recommendation (product types, free royal content). Data collection (of new products or embeddable items) can be done by monitoring web sources that provide such data. Filtering and decision of which royalty-free content to keep can be done using the history of sales, i.e., items A usually results in more sale then item B, etc.

Reactive recommendation may be included. The importance of an external signal for triggering new product recommendation is estimated. Given a signal (e.g., new trend), the importance of generating new products that reflect the trend is estimated. For example, how many “hits” are expected given that a decision to generate a product that will reflect the trend. (For example, given a quote of the day it is estimated how many people will be interested in buying product X with this new quote. This may be done using a history on previous related quotes by the same person, source, citations, etc.).

Other evaluations may include, the best basic products type to suggest and the royalty-free content and production capabilities there are to implement the product.

The described method may also include features extraction from the signal source for generating the product. Given that a signal comes from source X, a product may be generated that reflects the source. For example, in the microblogging trend example, the trend “Keep the Wave Going” triggered the suggestion of a t-Shirt, with a figure of wave. An extraction from the trend of the concept of “Wave” was carried out, then an image selected for use. In this example, the source context could also be used such as the microblogging service name with another image based on the general source context icon to make the product more attractive to the user.

Another aspect that may be included is constraint recommendation. The system must take into consideration the different production capabilities for a certain product recommendation, it might be that some of the possible candidate products will be discarded because there is no capability to produce them.

Automatic pricing of recommended products may be included. The system will be further capable of calculating the price of each dynamically generated product, using its baseline cost, its enhanced features costs, its production/order costs, and shipment costs.

As opposed to existing online advertisement and recommendation systems, the set of products that can be recommended for sale by the described system are not be bounded by the availability of current products for sale or pre-existing product features. Instead, the system will dynamically generate products for sale via online recommendation using baseline products that will be enhanced with targeted features (e.g., color) according to the system prediction. This flexibility allows the recommendation of new products that currently do not exist, but could have a potential for purchase if were recommended to users.

As a first example, consider a user that searches for “Barack Obama”. Given the user search keywords, the system may decide that the best baseline products that should be recommended for that user are a t-shirt and/or a coffee cup. Then, the system may decide to print a label over the baseline products with the best “quote-of-the-week” of president Barack Obama. It is further assumed that the system knows the gender of this specific searcher. Therefore, the system may further decide that the best colors for the baseline products should be either red or pink, and that the printed label color should be either red or white. The system further decides that two types of labeled t-shirts should be recommended to the user, one with an accompanying logo (e.g., some logo taken from president Barack Obama's last election campaign or relevant to the context of the chosen label), and one without. Finally, the system recommends three products to the user, a pink colored/white-labeled t-shirt with a logo, a red colored/white-labeled t-shirt with no logo, and a white coffee cup with some quote-of-the-week label printed on it.

As another example, assume a real-time microblogging system such as Twitter (http://www.twitter.com Twitter is a Trade Mark of Twitter, Inc.). In such a system, a signal may be a list of the latest (e.g., from last hour or so) trending topics. The system can use this signal to dynamically generate products that fit the current trends in the system. The exposure of new dynamically generated products may then attract the eye of potential shoppers (e.g., t-shirts with slogans related to the keywords taken from the list of trending topics (or even the trending topics themselves) and some related logo printed next to the slogan).

The described method and system have flexibility in that even products that currently do not exist in the system can be generated and proposed for sale. It also has dynamic capability to suggest dynamic products that are relevant to current ongoing events and trends and user preferences. Therefore, the system will be able to generate products that reflect current trends in the market, and suggest new products that reflect those trends. There is long tail coverage of new products that currently do not exist in the market, but may be reflected by the long tail can be recommended.

A recommendation system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for dynamic generation of products for online recommendation, comprising:
receiving a signal and processing the signal to extract one to many features;
locating baseline products and embeddable items relating to the features;
dynamically matching a baseline product with one or more embeddable items to generate a combined product;
providing a representation of the combined product as an online recommendation for a product;
wherein said steps are implemented in either:
computer hardware configured to perform said identifying, tracing, and providing steps, or
computer software embodied in a non-transitory, tangible, computer-readable storage medium.

2. The method as claimed in claim 1, including ranking the generated combined product representations based on the signal, the baseline products, the embeddable items, and the deployment of the embeddable items in the products.

3. The method as claimed in claim 1, including receiving a user or segment of users profile and customizing the product generation based on the profile.

4. The method as claimed in claim 1, including suggesting feature enhancements to the combined product based on features available for the baseline products.

5. The method as claimed in claim 1, including evaluating a price for the combined product based on the baseline product cost, enhanced features cost, production cost and shipment cost.

6. The method as claimed in claim 1, wherein the signal is an external signal generated online including one of the group of: an emerging trend, a social media buzz, an external event including quotes, a microblogging trend, social media, and popular advertisement.

7. The method as claimed in claim 1, wherein the signal is input by a user including one of the group of: search keywords, browsing history, user's profile, user bookmarks, comments, blog postings.

8. The method as claimed in claim 1, wherein an embeddable item includes royalty-free content.

9. The method as claimed in claim 1, including independently ranking located baseline products and ranking embeddable items.

10. The method as claimed in claim 1, wherein the combined products do not pre-exist.

11. The method as claimed in claim 1, including mapping a baseline product of a combined product to suppliers of the product.

12. A computer program product for dynamic generation of products for online recommendation, the computer program product comprising:
a computer readable storage medium having computer readable program code embodied therewith, the computer readable program code comprising:
computer readable program code configured to:
receive a signal and processing the signal to extract one to many features;
locate baseline products and embeddable items relating to the features;
dynamically match a baseline product with one or more embeddable items to generate a combined product; and
provide a representation of the combined product as an online recommendation for a product.

13. A system for dynamic generation of products for online recommendation, comprising:
a processor;
an incoming signal processing component for receiving a signal and processing the signal to extract one to many features;
a retrieving component for locating and retrieving baseline products and embeddable items relating to the features;
a matching component for dynamically matching a baseline product with one or more embeddable items to generate a combined product; and
a recommendation output component for providing a representation of the combined product as an online recommendation for a product.

14. The system as claimed in claim 13, wherein the retrieving component retrieves baseline products from multiple sources mapped to suppliers of the baseline products.

15. The system as claimed in claim 13, wherein the retrieving component retrieves embeddable items from multiple third party sources wherein the embeddable items include royalty-free content.

16. The system as claimed in claim 13, including a ranking component for ranking the generated combined product representations based on the signal, the baseline products, the embeddable items, and the deployment of the embeddable items in the products.

17. The system as claimed in claim 13, including a profile determining component for determining a user or segment of users profile and a personalization component for personalizing the combined product based on the user or segment of users profile.

18. The system as claimed in claim 13, including a feature enhancement component for adding feature enhancements to the combined product based on features available for the baseline products.

19. The system as claimed in claim 13, including a price evaluation component for evaluating a price for the combined product based on the baseline product cost, enhanced features cost, production cost and shipment cost.

20. The system as claimed in claim 13, wherein the signal is an external signal generated online including one of the group of: an emerging trend, a social media buzz, an external event including quotes, a microblogging trend, social media, and popular advertisement.

21. The system as claimed in claim 13, wherein the signal is input by a user including one of the group of: search keywords, browsing history, user's profile, user bookmarks, comments, blog postings.

22. The system as claimed in claim 13, wherein the combined products do not pre-exist in the system.

23. The system as claimed in claim 13, including a supplier component ordering a combined product from a supplier.

24. A method for providing a service to a customer over a network for dynamic generation of products for online recommendation, comprising:
receiving a signal and processing the signal to extract one to many features;
locating baseline products and embeddable items relating to the feature;
dynamically matching a baseline product with one or more embeddable items to generate a combined product;
providing a representation of the combined product as an online recommendation for a product;
wherein said steps are implemented in either:
computer hardware configured to perform said identifying, tracing, and providing steps, or
computer software embodied in a non-transitory, tangible, computer-readable storage medium.
